(19) United States
(12) Patent Application Publication
(10) Pub. No.: US 2015/0169438 A1
(43) Pub. Date: Jun. 18, 2015

(54) METHOD AND DEVICE FOR INCREMENTING AN ERASE COUNTER

(71) Applicant: Infineon Technologies AG, Neubiberg (DE)

(72) Inventors: Rex KHO, Holzkirchen (DE); Julie HENZLER, Munich (DE); Jens ROSENBUSCH, Munich (DE); Jörg SYASSEN, Oberhausen (DE)

(73) Assignee: Infineon Technologies AG, Neubiberg (DE)

(21) Appl. No.: 14/132,639

(22) Filed: Dec. 18, 2013

(51) Int. Cl. G06F 12/02

(52) U.S. Cl. CPC G06F 12/0246; G06F 2212/1032

(57) ABSTRACT

A method for incrementing an erase counter comprising several marker units is suggested, the method comprising the steps: (i) setting a marker unit in case a preceding marker unit was set; and (ii) not setting the marker unit in case the preceding marker unit was not set.

### BACKGROUND OF THE INVENTION

Embodiments of the present invention relate to processing of an erase counter that enables monitoring of data manipulation.

### SUMMARY

A first embodiment relates to a method for incrementing an erase counter comprising several marker units, the method comprising the steps:
setting a marker unit in case a preceding marker unit was set; and
not setting the marker unit in case the preceding marker unit was not set.

A second embodiment relates to a device comprising
an erase counter comprising several marker units;
a memory portion;
a processing unit that is arranged for incrementing the erase counter based on an erase procedure to be conducted on the memory portion by
   setting a marker unit in case a preceding marker unit was set; and
   not setting the marker unit in case the preceding marker unit was not set.

A third embodiment relates to a device for incrementing an erase counter comprising several marker units, the device comprising
means for setting a marker unit in case a preceding marker unit was set; and
means for not setting the marker unit in case the preceding marker unit was not set.

### BRIEF DESCRIPTION OF THE DRAWINGS

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

FIG. 1 shows a counter field in a memory device, e.g., a flash random access memory (flash RAM), comprising several marker units;

FIG. 2 shows a flow chart comprising steps of an exemplary implementation of an erase procedure utilizing the erase counter;

FIG. 3 shows an alternative embodiment utilizing an erase counter without any loop;

FIG. 4 shows a flow chart comprising steps of an exemplary implementation of an according erase procedure utilizing the erase counter.

### DETAILED DESCRIPTION OF THE PREFERRED EMBODIMENTS

Non-volatile memories (NVMs) can be programmed and erased by various software applications. The memory may be organized in a way that a group of bits are erased or programmed together. For example, a sector of the memory may be erased or a page of the memory may be programmed. For example, the page may comprise several bits and the sector may comprise several pages.

The examples presented herein allow determining how many erase cycles were conducted on a single sector or a group of sectors. This information may be useful to determine whether the memory has been tampered with, in particular whether the memory was subject to unauthorized changes.

It is noted that the sector mentioned herein is an example of a portion of a memory that can be erased, wherein the sector comprises at least one bit, in particular several bits or several pages. The memory mentioned may in particular be a memory device.

The erase counter concept may be used in any device that has persistent and re-programmable memory, e.g., NAND/NOR Flash, RRAM, MRAM, FeRAM. It may also be applicable for hard drives that have certain sectors set aside as erase counters to monitor if other sections have been erased and/or re-written.

Use cases may relate to scenarios with re-programmable firmware. Exemplary scenarios are: mobile phones, washing machines, engine control modules (e.g., in the automotive field), manufacturing robots in an assembly line, DVD players, game consoles, FPGA devices, etc.

The examples described herein hence in particular provide a non-volatile erase counter to monitor data manipulation.

A memory area is suggested comprising an erase counter for each sector. The memory area is in particular non-volatile. The memory area may be arranged such that it is read-only for application software (i.e. applications running on a device cannot modify this memory area as they wish).

Hence, the erase counter can be used to detect and prove manipulation of a software. For example: A ninth version of an official software release may be associated with eight erase operations which should be indicated by the erase counter. A higher number of erase cycles indicated by the erase counter may be a sign of unauthorized software manipulation.

Hence, the solution presented may be used for security applications or in order to supply evidence of tampering.

For example, the erase counter may be incremented when a sector is about to be erased. The modification of the erase counter may preferably be achieved without any chance of manipulation by the application software. Modification of the erase counter may preferably be encapsulated from an outside programming interface so that it cannot be avoided that any erase operation increments the erase counter.

Advantageously, the erase counter may be implemented in a way that it cannot be deleted by a customer; in particular the erase counter may be arranged such that it can only be deleted prior to the product, in particular the memory device, being shipped to the customer.

Tampering with the content of the memory (device) can be detected by storing the value of the erase counter (such value may be stored inside the memory device and/or external to the memory device) and compare this value with the actual value of the erase counter. The value of the erase counter may be stored after shipping of the memory device and/or after an authorized change (e.g., official update) of the software.

An exemplary implementation of the erase counter uses a thermometer code with a marker unit of at least one bit, in particular several bits. For example, each marker unit may comprise three bits or four bits thereby providing protection against bit errors.

Unary coding, also referred to as thermometer code, is an entropy encoding that represents a natural number, k, with k ones followed by a zero (if natural number is understood as non-negative integer) or with k−1 ones followed by a zero (if natural number is understood as strictly positive integer). For example, the number 5 is represented as 111110 or 11110. Some representations use k or k−1 zeroes followed by a one. The ones and zeroes are interchangeable without loss of generality. Unary coding is both a Prefix-free code and a self-synchronizing code (see, e.g., http://en.wikipedia.org/wiki/Thermometer_code).

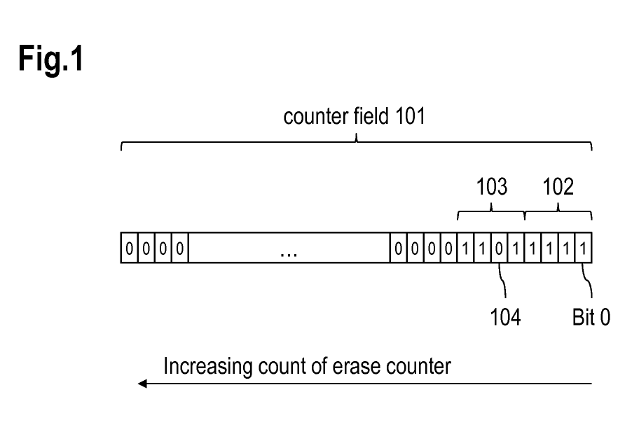

FIG. 1 shows a counter field 101 of a width amounting to b in a memory device, e.g., a flash random access memory (flash RAM), comprising a marker unit 102 and a marker unit 103. Each marker unit 102, 103 is n bits wide to compensate, e.g., for lack of coverage by an error correction code (ECC). Hence, single bit errors in the marker unit can be compensated by a majority decision: If at least three out of n=4 bits are “1”, the marker unit is deemed to be valid (and set); otherwise, no valid marker unit may be found. Of course, different values of n (other than four) can be used, wherein the majority decision is adjusted accordingly.

A maximum number of marker units within the counter filed 101 amounts to:

int (b/n),

i.e. the integer value of the division b/n. For example, if the counter field 101 width b amounts to 22 and the marker unit width amounts to 4, the (maximum) number of marker units that fits within the counter field 101 results in int(22/4)=5.

In the example shown in FIG. 1, the marker units 102 and 103 are both written, which corresponds to an erase counter value of “2”. Hence, starting from a bit 0, the first n=4 bits are set to “1” with the first maker unit being set; then, in case the erase counter is increased to 2, the next n=4 bits are set to “1” and so forth. With each increment, another n=4 bits are set to “1” and the remaining “0” in the counter field 101 decrease. Accordingly, with an increasing count of the erase counter, the counter field successively gets filled up.

However, in the example of FIG. 1, a single bit 104 within the marker unit 103 shows “0” instead of “1”, which may be due to a faulty memory cell or a faulty write operation. Such an error in bit 104 can be compensated based on a majority decision, i.e. based on the fact that the marker unit 103 shows a majority of cells amounting to “1”. Hence, the marker unit 103 is deemed written based on said majority decision.

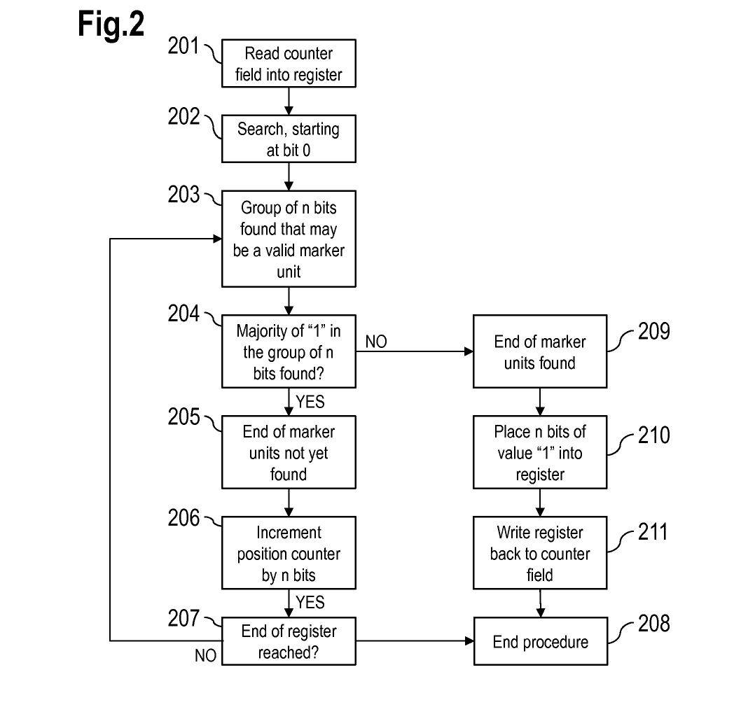

FIG. 2 shows a flow chart comprising steps of an exemplary implementation of an erase procedure utilizing the erase counter.

In a step 201 the counter field is read into a register.

In a step 202 a search is conducted in said register, starting at bit 0, for the first n bits that may or may not correspond to an already written n-wide marker unit.

In a step 203 n bits that may correspond to a valid marker unit are found.

In a step 204 it is checked whether there is majority of “1” in these n bits.

If this is true, the end of the marker units has not yet been found (this is determined in a step 205) and a position counter is incremented by n bits (in a step 206). In a next step 207 it is checked whether the end of the register is reached (if the position counter reaches or exceeds a maximum count). If this is not the case, the procedure continues with the step 203. If the condition of step 207 is true, however, the procedure ends in a step 208.

If the condition checked in step 204 is not true, i.e. if there is no majority of “1” in the n bits, it is branched to a step 209 determining that an end of the marker units has been found. Next, in a step 210, n bits of value “1” are placed into the register and in a step 211 the register is written back to the counter field. Subsequently to step 211 the procedure ends in the step 208.

Hence, each single sector may have a counter field and within the counter field a (valid) marker unit is searched which shows a majority of written cells (i.e. a majority of “1”) and a minority of erased cells (i.e. a minority of “0”). However, dependent on the implementation, comparison functions other than the majority can be used. For example, at least one or at least two written cells can be used to determine a (valid) marker unit. This is in particular beneficial in case error correction codes are available.

If such marker unit is determined, the next n cells are written in order to increase the erase counter.

As an option, the written cells can be checked. In case the write operation was not successful (e.g., due to external manipulation), the sector selected will not be erased and an error may be indicated.

Advantageously, the erase counter can be read and it can thus be determined how often the sector has been erased. This number can be compared to the number of valid erased procedures in order to find out whether the memory was manipulated.

### EXEMPLARY EMBODIMENT

### Erase Counter without Loops

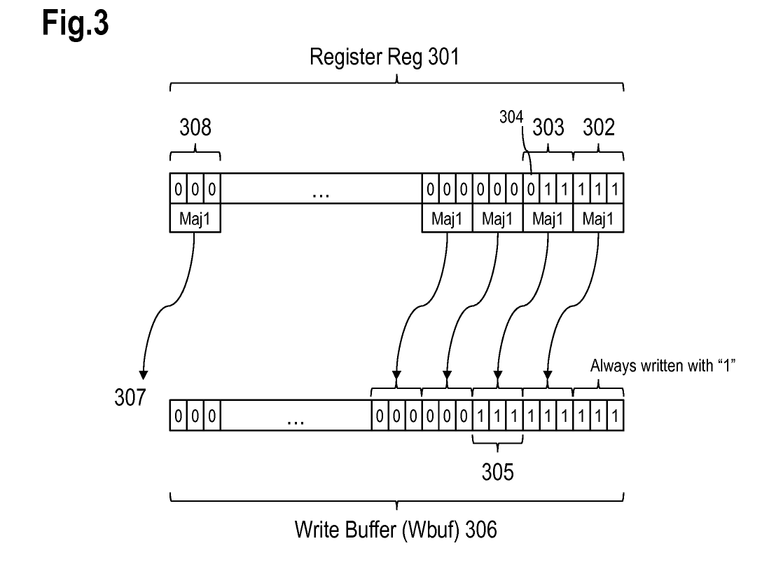

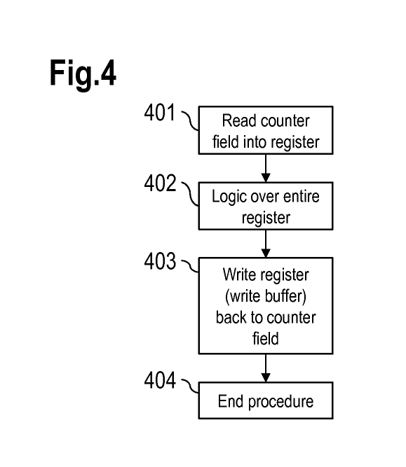

FIG. 3 shows an alternative embodiment utilizing an erase counter without any loop. FIG. 4 shows a flow chart comprising steps of an exemplary implementation of an according erase procedure utilizing the erase counter.

The counter field is read to a register Reg 301 (see step 401). The register Reg 301 exemplarily shows two marker units 302 and 303 (that have already been set in order to increase the erase count), wherein the marker units have an exemplary width of n=3 bits. In the example shown in FIG. 3, the marker unit 302 has a single error in a bit 304 (showing “0” instead of “1”), which can be compensated based on a majority decision, i.e., because of the remaining two bits of the marker unit 302 amounting to “1”.

Initially, the first n=3 bits of the write buffer WBuf 306 are set to “1”.

With each iteration of the procedure a subsequent marker unit is written to the write buffer and to the counter field indicating an increase of the erase counter.

For n bits of the marker unit, a majority decision is provided (indicated in FIG. 3 by “Maj1”) to decide whether or not this marker unit was already set (used). If this is the case, the next marker unit is set to “1” in the write buffer 306, i.e. the n bits of the next marker unit are set to “1”. This is conducted over the entire register Reg 301 (see step 402) without requiring any loop.

The operation conducted corresponds to the following formulas:

WBuf<n−1:0>=1

WBuf<n*(m+2)−1:n*(m+1)>=Maj1(Reg<n*(m+1)−1:n*m>

Where m=0 to int(b/n)

wherein
WBuf<a:b> indicates bits a to b of the write buffer 306;
n indicates the bit width of the marker unit;
b indicates the bit width of the counter field;
int(b/n) is the number of markup units that fit in the counter field;
Maj1 indicates a majority-1 logic, i.e. a logic that determines whether the majority of a n bit group equals “1”; if the majority condition is fulfilled, n bits amounting to “1” are written to the next n bits of the writ buffer.

Then, the write buffer 306 is written back to the counter field (see step 403). In a next step 404, the procedure may end.

Hence, based on the example shown in FIG. 3, the first two marker units 302 and 303 have already been set. Hence, in a subsequent erase operation, a next marker 305 will be set based on the majority decision for the previous marker 303.

Therefore, as a result of the subsequent erase operation, the write buffer (WBuf) 306 is written back to the counter field.

This example bears the advantage that no loop is required. Instead, the register Reg 301 is processed based on the majority decision for each bunch of n bits, i.e. for each potential marker unit thereby setting or not setting the next n bits to “1”. The result is stored in the write buffer (WBuf) 306 before it is written to the counter field.

It is also an advantage that no search operation is required for a chain of “1” to determine the last used marker unit.

As a further advantage, faulty bits within the counter field that do not show a majority of “1” (e.g., due to degradation effects over time) do not affect incrementing the erase counter.

Also, an overflow signal 307 based on the last marker unit 308 of the counter field or the register Reg 301 can be used to indicate that the erase counter is full or to extend the erase counter.

The examples suggested herein may in particular be based on at least one of the following solutions. In particular combinations of the following features could be utilized in order to reach a desired result. The features of the method could be combined with any feature(s) of the device, apparatus or system or vice versa.

A method is provided for incrementing an erase counter comprising several marker units, the method comprising the steps:
setting a marker unit in case a preceding marker unit was set; and
not setting the marker unit in case the preceding marker unit was not set.

It is noted that the marker units may be arranged in an ascending order such that the marker unit may be set one after another to represent an increasing count of the erase counter. The marker unit may thus be used to successively fill the erase counter, wherein setting a single marker may be an increment of such erase counter. Preferably, the erase counter can only be set, not re-set. This allows determining the number of erase cycles or erase operations applied to a portion of a memory, e.g., a sector or a page of the memory.

It is further noted that incrementing the erase counter may comprise an increase by one or an increase by a value larger than one.

Advantageously, the solution allows determining how many erase cycles were conducted on said portion of the memory, i.e. on a single sector or a group of sectors of the memory. This information can be used to determine whether the memory has been tampered with, in particular whether the memory was subject to unauthorized changes.

It is further noted that erase cycles on a hard drive or a portion of the hard drive (e.g., sector) can be counted via the erase counter as described herein.

In an embodiment, the erase counter is associated with a portion of a memory, in particular a non-volatile memory, and wherein an erase operation applied to said portion of the memory triggers incrementing the erase counter.

In an embodiment, the erase counter is part of a non-volatile memory, wherein the memory of the erase counter is not accessible or read-only to an application software.

In an embodiment, the erase counter is a non-volatile erase counter.

In an embodiment, each marker unit comprises several bits, wherein the marker unit is set based on a majority decision of bits set in the preceding marker unit.

The preceding marker unit is the marker unit that was set before the actual marker unit, e.g., the direct predecessor in a unary code.

In an embodiment, each marker unit has a width of at least two bits, wherein the marker unit is set based on an operation utilizing the bits of the preceding marker unit.

In an embodiment, the operation is a majority decision.

The majority decision is an example of how to utilize the redundancy of the marker units. However, other operations may be applied accordingly. It is also possible to use a code with redundancy or an error detection code and/or an error correction code to determine if the marker unit was correct.

In an embodiment, the method comprises the step:
setting the marker unit before an actual erase of a portion of a memory, in particular a sector or a page of a non-volatile memory.

In an embodiment, each marker unit corresponds to a single count value of a unary code or a thermometer code.

The unary code utilizes a single bit to increase a count value. The marker unit, however, may comprise several bits which are preferably set to the same value to indicate an increase of the count value.

In an embodiment, the marker unit is set by setting all bits of the marker unit to the same value.

In an embodiment, a marker unit is not set by setting all bits of the marker unit to the same value, which is different from the value used for setting the marker unit.

If the marker unit uses, e.g., four bits, setting the marker unit may lead to setting all of its bits to “1”, which results in a marker unit of “1111”. On the other hand, “not setting” the marker unit may lead to setting all of its bits to “0” or leaving the bits unchanged at the value “0”.

In an embodiment, the method comprises the steps:
reading the erase counter and storing it in a register;
searching for the last marker unit in the register that was set;
setting the marker unit that is subsequent to the last marker unit; and
writing the register back to the erase counter.

In an embodiment, the method comprises the step:
indicating an error in case writing the register back to the erase counter was not successful.

In an embodiment, the method comprises the steps:
reading the erase counter and storing it in a register;
writing each marker unit in a write buffer, wherein each marker unit is set or not set based on an operation utilizing the bits of the respective preceding marker unit; and
writing the write buffer to the erase counter.

In an embodiment, the operation is a majority decision and wherein such majority decision is available for each of the marker units read to the register.

For example, majority decision hardware may be provided, which is coupled to the bits of each marker unit that is stored in the register. Hence, the write buffer can be directly written for each subsequent marker unit without the need for time consuming loops.

In an embodiment, the method comprises the step:
issuing an overflow indication in case the highest marker unit in the register is set.

In an embodiment, the overflow indication is used to extend the erase counter.

Also, a device is provided, said device comprising
an erase counter comprising several marker units;
a memory portion;
a processing unit that is arranged for incrementing the erase counter based on an erase procedure to be conducted on the memory portion by
   setting a marker unit in case a preceding marker unit was set; and
   not setting the marker unit in case the preceding marker unit was not set.

Said processing unit may be any processing device that may be provided together with the memory on the same chip or die or external to the memory. The processing unit may comprise portions of hardware, software and/or firmware. The processing unit may be arranged in a distributed way among several components or it may be a single piece of hardware. The memory portion may be a sector or a page of a (non-volatile) memory. The memory portion can be erased in a single erase step. The erase counter may be a physical part of the memory that also contains the memory portion. As an alternative, the erase counter may be located on a separate memory device. The erase counter may be a counter coded according to an unary code, e.g., a thermometer code.

The device may in particular be a (single) chip or an arrangement comprising several chips. A chip may comprise an integrated circuit, a die and/or a semiconductor device.

In an embodiment, the device is implemented on a single chip or die.

In an embodiment, the memory portion is part of a non-volatile memory.

In an embodiment, the memory portion comprises at least one of the following
floating gate cells;
PCRAM,
RRAM,
MRAM,
MONOS devices,
nano crystal cells,
FeRAM,
hard drive,
non-volatile storage.

In an embodiment, the erase counter is arranged such that it is not accessible to an application software or that it is read-only to the application software.

In an embodiment, the processing unit is arranged for
reading the erase counter and storing it in a register;
searching for the last marker unit in the register that was set;
setting the marker unit that is subsequent to the last marker unit; and
writing the register back to the erase counter.

In an embodiment, the processing unit is arranged for indicating an error in case writing the register back to the erase counter was not successful.

In an embodiment, the processing unit is arranged for
reading the erase counter and storing it in a register;
writing each marker unit in a write buffer, wherein each marker unit is set or not set based on an operation utilizing the bits of the respective preceding marker unit; and
writing the write buffer to the erase counter.

In an embodiment, the operation is a majority decision and wherein such majority decision is available for each of the marker units read to the register.

Further, a device is suggested for incrementing an erase counter comprising several marker units, the device comprising:
means for setting a marker unit in case a preceding marker unit was set; and
means for not setting the marker unit in case the preceding marker unit was not set.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

1. A method for incrementing an erase counter comprising several marker units, the method comprising the steps:
setting a marker unit in case a preceding marker unit was set; and
not setting the marker unit in case the preceding marker unit was not set.

2. The method according to claim 1, wherein the erase counter is associated with a portion of a memory, in particular a non-volatile memory, and wherein an erase operation applied to said portion of the memory triggers incrementing the erase counter.

3. The method according to claim 1, wherein the erase counter is part of a non-volatile memory, wherein the memory of the erase counter is not accessible or read-only to an application software.

4. The method according to claim 1, wherein the erase counter is a non-volatile erase counter.

5. The method according to claim 1, wherein each marker unit comprises several bits, wherein the marker unit is set based on a majority decision of bits set in the preceding marker unit.

6. The method according to claim 1, wherein each marker unit has a width of at least two bits, wherein the marker unit is set based on an operation utilizing the bits of the preceding marker unit.

7. The method according to claim 6, wherein the operation is a majority decision.

8. The method according to claim 1, comprising the step:
setting the marker unit before an actual erase of a portion of a memory, in particular a sector or a page of a non-volatile memory.

9. The method according to claim 1, wherein each marker unit corresponds to a single count value of a unary code or a thermometer code.

10. The method according to claim 1, wherein the marker unit is set by setting all bits of the marker unit to the same value.

11. The method according to claim 1, wherein a marker unit is not set by setting all bits of the marker unit to the same value, which is different from the value used for setting the marker unit.

12. The method according to claim 1, comprising the steps:
reading the erase counter and storing it in a register;
searching for the last marker unit in the register that was set;
setting the marker unit that is subsequent to the last marker unit; and
writing the register back to the erase counter.

13. The method according to claim 12, comprising the step:
indicating an error in case writing the register back to the erase counter was not successful.

14. The method according to claim 1, comprising the steps:
reading the erase counter and storing it in a register;
writing each marker unit in a write buffer, wherein each marker unit is set or not set based on an operation utilizing the bits of the respective preceding marker unit; and
writing the write buffer to the erase counter.

15. The method according to claim 14, wherein the operation is a majority decision and wherein such majority decision is available for each of the marker units read to the register.

16. The method according to claim 14, comprising the step:
issuing an overflow indication in case the highest marker unit in the register is set.

17. The method according to claim 16, wherein the overflow indication is used to extend the erase counter.

18. A device comprising
an erase counter comprising several marker units;
a memory portion;
a processing unit that is arranged for incrementing the erase counter based on an erase procedure to be conducted on the memory portion by
setting a marker unit in case a preceding marker unit was set; and
not setting the marker unit in case the preceding marker unit was not set.

19. The device according to claim 18, wherein the device is implemented on a single chip or die.

20. The device according to claim 18, wherein the memory portion is part of a non-volatile memory.

21. The device according to claim 18, wherein the memory portion comprises at least one of the following
floating gate cells;
PCRAM,
RRAM,
MRAM,
MONOS devices,
nano crystal cells,
FeRAM,
hard drive,
non-volatile storage.

22. The device according to claim 18, wherein the erase counter is arranged such that it is not accessible to an application software or that it is read-only to the application software.

23. The device according to claim 18, wherein the processing unit is arranged for
reading the erase counter and storing it in a register;
searching for the last marker unit in the register that was set;
setting the marker unit that is subsequent to the last marker unit; and
writing the register back to the erase counter.

24. The device according to claim 18, wherein the processing unit is arranged for indicating an error in case writing the register back to the erase counter was not successful.

25. The device according to claim 18, wherein the processing unit is arranged for
reading the erase counter and storing it in a register;
writing each marker unit in a write buffer, wherein each marker unit is set or not set based on an operation utilizing the bits of the respective preceding marker unit; and
writing the write buffer to the erase counter.

26. The device according to claim 18, wherein the operation is a majority decision and wherein such majority decision is available for each of the marker units read to the register.

27. A device for incrementing an erase counter comprising several marker units, the device comprising:
means for setting a marker unit in case a preceding marker unit was set; and
means for not setting the marker unit in case the preceding marker unit was not set.
